(19) United States
(12) Patent Application Publication
(10) Pub. No.: US 2016/0333824 A1
(43) Pub. Date: Nov. 17, 2016

(54) HYDRAULIC CONTROL FOR A THRUST REVERSER OF A TURBOJET ENGINE, INCLUDING A VARIABLE-DISPLACEMENT MACHINE

(71) Applicant: AIRCELLE, Gonfreville L'Orcher (FR)

(72) Inventors: Vincent Pierre Germain LE COQ, Saint Romain De Colbosc (FR); Vincent PRAT, Le Mesnil Le Roi (FR)

(73) Assignee: AIRCELLE, Gonfreville L'Orcher (FR)

(21) Appl. No.: 15/219,711

(22) Filed: Jul. 26, 2016

Related U.S. Application Data
(63) Continuation of application No. PCT/FR2015/050181, filed on Jan. 27, 2015.

(30) Foreign Application Priority Data
Jan. 27, 2014 (FR) 14/50651

(51) Int. Cl. F02K 1/76; F15B 11/04

(52) U.S. Cl. CPC F02K 1/763; F15B 11/04; F05D 2260/406; F15B 2211/7058; F15B 2211/715; F15B 2211/763

(57) ABSTRACT

A hydraulic control system of a thrust reverser for a turbojet engine nacelle includes a hydraulic machine fed by a pressure source, which motorizes actuators carrying out the thrust reverser stroke, wherein the hydraulic machine includes a variable displacement.

### CROSS-REFERENCE TO RELATED APPLICATIONS

This application is a continuation of International Application No. PCT/FR2015/050181, filed on Jan. 27, 2015, which claims the benefit of FR 14/50651 filed on Jan. 27, 2014. The disclosures of the above applications are incorporated herein by reference.

### FIELD

The present disclosure concerns a hydraulic control of a thrust reverser for an aircraft nacelle receiving a turbojet engine, as well as an aircraft nacelle equipped with such a hydraulic control.

### BACKGROUND

The statements in this section merely provide background information related to the present disclosure and may not constitute prior art.

In general, motorized assemblies for aircraft include a nacelle forming a generally circular external envelope, comprising thereinside a turbojet engine disposed along the axis of this nacelle. The turbojet engine receives fresh air coming from the upstream or front side, and discharges, on the downstream or rear side, the hot gases resulting from the combustion of fuel, which provide a certain thrust.

Turbofan engines present, around this turbojet engine, fan blades generating a significant secondary cold air flow along an annular flow path passing between the engine and the nacelle, which adds a high thrust.

Some nacelles include a thrust reverser system which closes, at least in part, the cold air annular flow path, and discharges the secondary flow forward in order to generate a braking thrust of the aircraft.

A known type of thrust reverser, presented in particular in document FR-A1-2758161, includes rear movable cowls called “Trans-cowl,” sliding axially rearward under the effect of cylinders by deploying flaps in the annular flow path in order to close a major portion of this flow path. The flaps return the cold air flow radially outward by passing through cascades uncovered by the movable cowls during their sliding movements, comprising blades which direct this flow forward.

Originally, the cascade-type thrust reversers were motorized by a pneumatic motor using a pressure supplied by the compressor stages of the turbojet engine. The pneumatic motor was driving, via shafts, actuators each of which including a mechanical cylinder using a ball screw system, thereby allowing synchronizing all of these cylinders so as to obtain a translation of the cowls.

This type of motorization is no longer produced because it poses several problems, in particular a significant bulk size of the pneumatic motor, an available pressure which varies considerably depending on the speed of the turbojet engine, a compressibility of the air providing the energy which does not allow for a sufficiently reactive control of the motor, and the dependence on the environmental conditions, such as frost.

Another known type of motorization includes an electric motor which, like the pneumatic motor, motorizes a drive train driving the different actuators in a synchronized manner. This solution requires providing a significant electric power which cannot be provided by all aircraft.

Another known type of motorization includes several linear hydraulic actuators fed by a pressurized fluid source, provided with internal screws which allow synchronizing these different actuators. This solution is relatively heavy, complicated, and consumes a large part of the hydraulic flow rate of the aircraft.

As a variant, it is possible to dispose one single hydraulic engine which motorizes a drive train driving the different actuators in a synchronized manner.

Nonetheless, for these hydraulic solutions, in order to obtain a high torque for starting the hydraulic motor and beginning the movement of the thrust reverser, as well as for braking these elements at the end-of-stroke, a displacement of the hydraulic motor which is large enough is then required. In particular, an abrupt end-of-stroke would result in impacts on the system and on the structure which should be avoided.

However, this significant displacement will result, during the intermediate phase of the displacement of the thrust reverser at constant speed, which no longer requires a significant torque, in a high flow rate of the fluid which imposes a pressurized fluid reserve including a sufficient volume. Thus, the bulk size as well as the mass of the hydraulic system are considerable. The compromise is then difficult to achieve in order to satisfy these different operating conditions.

In addition, the control of the speed ramp including an acceleration at the beginning and a deceleration at the arrival, in order to optimize the duration of maneuver while reducing the mechanical stresses, is difficult to realize in a simple, reliable and economical manner.

### SUMMARY

The present disclosure includes a hydraulic control of a thrust reverser for a turbojet engine nacelle, including at least one hydraulic machine fed by a pressure source, which motorizes actuators carrying out the thrust reverser stroke, characterized in that this hydraulic machine includes a variable displacement.

One advantage of this hydraulic control is that it is possible to obtain both a high torque at startup of the motor by using the maximum displacement, and a considerable speed with a reduced torque for the operation at a constant speed by using a smaller displacement, which reduces the consumption of fluid.

In addition, the control of the accelerations and of the braking of this type of motor is facilitated by adjusting the displacement, which allows using proportional type solenoid valves for controlling the flow rate, instead of servo-controlled solenoid valves which are less reliable and more expensive.

In addition, the hydraulic control according to the present disclosure may include one or more of the following features, which may be combined together.

Advantageously, the hydraulic control includes a brake controlled by a hydraulic cylinder, blocking the stroke of the actuators, which is closed in the absence of hydraulic pressure. Thus, improved safety is provided by blocking the thrust reverser in the case of the absence of hydraulic pressure.

In this case, the hydraulic cylinder for controlling the brake may be fed by a valve normally closed in the absence of control. Thus, improved safety is provided by blocking the thrust reverser in the case of failure of the control of the hydraulic circuit.

Advantageously, the mechanical linkage between the hydraulic machine and the actuators includes flexible shafts. Thus, synchronization is achieved in a simple manner between the different actuators distributed around the nacelle of the turbojet engine.

Advantageously, the mechanical linkage between the hydraulic machine and the actuators includes a manual control means of these actuators. This means allows interventions by displacing the thrust reverser when its control system is stopped.

Advantageously, the hydraulic control comprising two pressure lines feeding the hydraulic machine, includes an equalizer valve disposed on one of these lines, which is controlled by the pressure of the other line, in order to automatically adapt a fluid passage restriction at the outlet of this machine when it operates as a generator.

Advantageously, the hydraulic control includes a sequence valve which, in a controlled position, connects a pressure line of the hydraulic machine to the pressure source, and the other pressure line to a low-pressure reservoir, and in another controlled position, reverses these connections of the pressure lines.

Advantageously, when at rest, the sequence valve includes passage restrictions allowing for a progressive decrease of pressure in this control. Thus, only a small loss of pressure in the control circuit may occur when switching from one controlled position to the other, and improved safety with a drop of this pressure in the absence of the valve control is provided.

Advantageously, the hydraulic control includes a control of the regulating distributors of the displacement of the hydraulic machine, based on the level of load pressure of this machine. Thus, a flexible adaptation for adjusting the displacement of the hydraulic machine is obtained.

Advantageously, the hydraulic control includes means which, according to the measured stroke of the thrust reverser, control in a closed loop the regulating distributors of the displacement which are of the proportional control type.

In this case, the regulating distributors of the displacement may be piloted more advantageously, for example by pulse width modulators of the “PWM” type.

Further areas of applicability will become apparent from the description provided herein. It should be understood that the descriprion and specific examples are intended for purposes of illustration only and are not intended to limit the scope of the present invention.

### DRAWINGS

In order that the disclosure may be well understood, there will now be described various forms thereof, given by way of example, reference being made to the accompanying drawing, in which:

FIG. 1 is a hydraulic control circuit of a thrust reverser, containing a hydraulic machine 30 with a variable displacement operating as a motor in order to actuate the mechanism of this thrust reverser, and as a generator by receiving a mechanical power of the thrust reverser when braking its movement.

The drawing described herein is for illustration purposes only and is not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

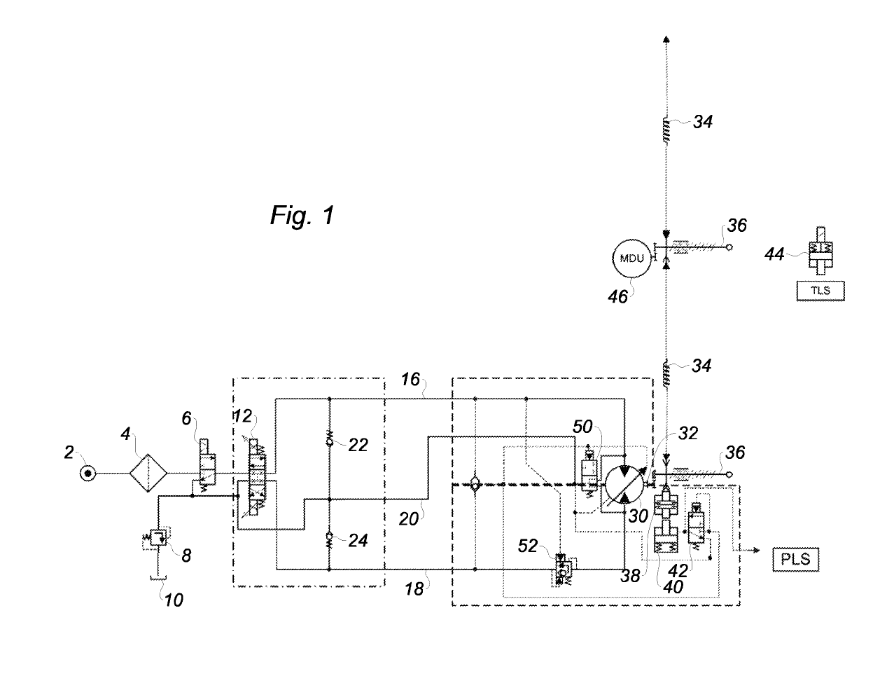

Referring to FIG. 1, an illustrated hydraulic circuit receives fluid from a hydraulic pressure source 2, by passing through an inlet filter 4.

The pressurized fluid is transmitted to the circuit by a safety solenoid valve 6, which is open in an activated position in order to feed the hydraulic control circuit, and which is closed in the absence of signal in order to improve safety, by putting this circuit in communication with a reservoir 10 at atmospheric pressure.

Afterwards, the arriving pressurized fluid passes via a sequence valve 12, which, in a first controlled position, provides the feeding of an upper pressure line 16 by the pressure source 2 so as to deliver energy to the hydraulic machine 30 operating as a motor, the return of the fluid to the reservoir 10 being done via a lower pressure line 18.

In a second controlled position, the sequence valve 12 reverses these two connections, by feeding of the lower pressure line 18 by the pressure source 2 so as to make the hydraulic machine 30 operate as a motor in the other direction, the return to the reservoir 10 being done via the upper pressure line 16.

The sequence valve 12 includes a central rest position which connects the two pressure lines 16, 18 to the reservoir 10 with significant flow rate restrictions so as to allow for a progressive drop of pressure in the control circuit.

The return to the reservoir 10 is done by a pressure-limiting valve 8, maintaining a pressure of 10 bars in the return line, which may be the upper 16 or lower 18 line, depending on the position of the sequence valve 12.

The hydraulic machine 30 includes a control of its variable displacement, which is not represented in this diagram.

A leakage return 20 recovers the leakages of the hydraulic machine 30 and its variable displacement control to convey them toward the reservoir 10. Two check valves 22, 24 comprising a calibration spring calibrated to 0.5 bars, are disposed between the leakage return 20 and the upper pressure line 16 as well as the lower pressure line 18, in order to avoid overpressure in this leakage return when discharging the fluid in one of these two pressure lines.

The hydraulic machine 30 directly drives, via a speed reduction gear 32, a first screw-ball nut type mechanical cylinder 36 and, via flexible shafts 34 which allow turning around the nacelle of the turbojet engine, other similar mechanical cylinders 36 which then have a synchronized movement. Thus, a linear displacement of the thrust reverser is achieved, this remaining parallel to the axis of the nacelle.

A manual control device 46 allows directly driving the flexible shafts 34 by a control handle, in order to maneuver the mechanical cylinders 36 in the event of a stoppage or breakdown of the motorization. Thus, possibilities of intervention or maintenance are provided.

A mechanical brake 38 comprising stacked brake discs, disposed at the end of the line of the flexible shafts 34, is controlled by a hydraulic cylinder 40 comprising a load spring which constantly maintains the brake closed in the case of absence of hydraulic pressure. A hydraulic valve 42, comprising a closed position when at rest and an open position when active, controls this brake.

In this manner, improved safety is provided by stopping the movement of the actuators 36 and by maintaining their positions, in the case of a failure of the control of the solenoid valve 42 or of the hydraulic pressure.

A bypass hydraulic valve 50 disposed parallel to the hydraulic machine 30, includes, at rest, an open position which frees a fluid passage between the upper pressure line 16 and the lower pressure line 18, and when in the closed position, interrupts this passage thereby allowing this machine to operate.

An equalizer valve 52 disposed between the lower connection of the hydraulic machine 30 and the lower pressure line 18, is controlled by the pressure of the upper line 16 in order to automatically adapt a fluid passage restriction at the outlet of this machine when it operates as a generator, based on its output pressure as well as on the pressure of the upper line feeding it. Thus, braking of the hydraulic machine 30 operating as a generator is automatically achieved, in order to dissipate a braking power in the pressure return toward the reservoir 10.

As a complement, another equalizer valve, which is not represented, may be disposed in the same manner on the upper pressure line 16 at the inlet of the hydraulic machine 30 so as to retain the load on this machine if stopped, without urging the mechanical brake 38.

The operation of this control circuit includes at the beginning of the movement of the thrust reverser being deployed, positioning of the hydraulic machine 30 in a large displacement in order to obtain a high starting torque with the supply via the upper pressure line 16, then switching into a reduced displacement in order to obtain a high speed of displacement with a low fluid consumption.

During this displacement, a closure of the flaps of the thrust reverser disposed in the cold air annular flow path is achieved, which flaps return the flow through the diverting means forwardly of the aircraft. The thrust of the cold air flow on the flaps generates a large load on these flaps which tends to close them, their strokes then drive the hydraulic machine 30 which switches into the generator operation mode, with a braking of this machine by the equalizer valve 52 disposed at the outlet.

As we approach the end-of-stroke, a large displacement of the hydraulic machine 30 is then progressively reestablished, in order to obtain a more and more significant braking torque depending on the decrease of its speed of rotation.

In order to close the thrust reverser, a similar cycle is performed with a reverse movement of the hydraulic machine 30, this machine operating first as a motor with a supply by the lower pressure line 18, connected to the pressure source 2 by positioning the sequence valve 12 in the corresponding position.

In most cases, stresses are considerably reduced at the end of the stroke of the thrust reverser, in particular after high translational speeds in the middle of the stroke, by the large-displacement position of the hydraulic machine 30 delivering a high braking torque.

Moreover, the regulating distributor of the displacement of the hydraulic machine 30 is advantageously adjusted based on the level of the load pressure of this machine, thereby allowing for a flexible adaptation allowing to simplify the initially-provided speed ramp tracking control.

It is then possible in this case to choose a regulating distributor of the displacement which is less accurate than a servo valve, including proportional control solenoids which may be controlled in a closed loop based on the thrust reverser stroke measured by a sensor which measures a rotation or a displacement of a mechanical element related to the displacement of this thrust reverser.

In particular, it is possible to pilot this regulating distributor of the displacement in a simple manner by pulse width modulation, of the “PWM” (Pulse Width Modulation) type.

It will be noted that proportional control distributors are generally less accurate than servo valves, which is compensated by the higher flexibility of piloting given by the variation of the displacement of the hydraulic machine 30.

As a variant, a more complex servo-control includes measuring the control pressure of the variable displacement of the hydraulic machine 30 in order to servo-control this adjustment of displacement more accurately.

One or several variable displacement motor(s) may be used in the context of the present disclosure. The use of several motors includes many advantages, in particular a redundancy for enhancing the operational availability of the function.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A hydraulic control system of a thrust reverser for a turbojet engine nacelle, including at least one hydraulic machine fed by a pressure source, which motorizes actuators carrying out a thrust reverser stroke, wherein the hydraulic machine includes a variable displacement.

2. The hydraulic control system according to claim 1 further comprising a brake controlled by a hydraulic cylinder, the brake blocking a stroke of the actuators, the brake being closed in the absence of hydraulic pressure.

3. The hydraulic control system according to claim 2, wherein the hydraulic cylinder for controlling the brake is fed by a valve, the valve being normally closed in the absence of control.

4. The hydraulic control system according to claim 1 further comprising a mechanical linkage between the hydraulic machine and the actuators.

5. The hydraulic control system according to claim 1, wherein the mechanical linkage includes flexible shafts.

6. The hydraulic control system according to claim 4, wherein the mechanical linkage between the hydraulic machine and the actuators includes a manual control of the actuators.

7. The hydraulic control system according to claim 1 further comprising:
two pressure lines feeding the hydraulic machine; and
at least one equalizer valve disposed on at least one of the pressure lines, the equalizer valve being controlled by pressure of the other line in order to automatically adapt a fluid passage restriction at an outlet of the hydraulic machine when the hydraulic machine operates as a generator.

8. The hydraulic control system according to claim 1 further comprising a sequence valve which, in a controlled position, connects a pressure line of the hydraulic machine to the pressure source, and another pressure line to a low-pressure reservoir, and in another controlled position, reverses connections of the pressure lines.

9. The hydraulic control system according to claim 8, wherein when at rest, the sequence valve includes passage restrictions allowing for a progressive decrease of pressure.

10. The hydraulic control system according to claim 1 further comprising control of a regulating distributor of the variable displacement of the hydraulic machine, based on a level of a load pressure of the hydraulic machine.

11. The hydraulic control system according to claim 1 further comprising a device which, according to a measured stroke of the thrust reverser, controls in a closed loop regulating distributors of a displacement which are of a proportional control type.

12. The hydraulic control system according to claim 11, wherein the regulating distributors of the displacement are piloted by pulse width modulation (PWM).

13. A nacelle of a turbojet engine including a thrust reverser with a hydraulic control, wherein the control is achieved according to claim 1.
